(19) United States
(12) Patent Application Publication
(10) Pub. No.: US 2011/0219173 A1
(43) Pub. Date: Sep. 8, 2011

(54) SEMICONDUCTOR MEMORY SYSTEM

(75) Inventor: Takeo MORITA, Tokyo (JP)

(73) Assignee: Kabushiki Kaisha Toshiba, Tokyo (JP)

(21) Appl. No.: 13/039,999

(22) Filed: Mar. 3, 2011

(30) Foreign Application Priority Data
Mar. 3, 2010 (JP) 2010-046919

(51) Int. Cl. G06F 12/14; G06F 12/00

(52) U.S. Cl. 711/103; 711/163; 711/105; 711/E12.008; 711/E12.091

(57) ABSTRACT

According to one embodiment, there is provided a semiconductor memory system including a controller and a memory unit. The controller includes a generation unit, an association unit, a retaining unit, an encoding/decoding unit, and a determination unit. When the access request information is managed, the encoding/decoding unit performs, without generating an obfuscation information by the generation unit, an encoding processing or a decoding processing by using the obfuscation information retained in the retaining unit. And when the access request information is not managed, the encoding/decoding unit performs, after the generation unit generates obfuscation information based on the access request information, the encoding processing or the decoding processing.

### CROSS-REFERENCE TO RELATED APPLICATIONS

This application is based upon and claims the benefit of priority from the prior Japanese Patent Application No. 2010-46919, filed on Mar. 3, 2010; the entire contents of which are incorporated herein by reference.

### FIELD

Embodiments described herein relate generally to a semiconductor memory system.

### BACKGROUND

A technology for preventing unauthorized access to a program itself and information handled by the program in open system computers for ordinary users has been proposed (for example, see Japanese Patent Laid-Open Publication No. 2003-108442).

### BRIEF DESCRIPTION OF THE DRAWINGS

FIG. 1 is a schematic block diagram showing one example of a configuration of a semiconductor memory device;

FIG. 2 is a schematic block diagram showing one example of a configuration of an obfuscation processing unit of a controller according to a first embodiment;

FIG. 3 is a flow chart showing one example of a control method in the case of a data access according to the first embodiment;

FIG. 4 is a schematic block diagram showing one example of a configuration of an obfuscation processing unit of a controller according to a second embodiment;

FIGS. 5A and 5B are flowcharts showing one example of a control method in the case of a data access according to the second embodiment;

FIG. 6 is a schematic block diagram showing one example of a configuration of an obfuscation processing unit of a controller according to a third embodiment;

FIGS. 7A and 7B are flowcharts showing one example of a control method in the case of a data access according to the third embodiment;

FIGS. 8A and 8B are diagrams showing one example of a case in which data writing and reading occur at predetermined intervals;

FIG. 9 is a schematic block diagram showing one example of a configuration of an obfuscation processing unit of a controller according to a fourth embodiment; and

FIGS. 10A and 10B are flowcharts showing one example of a control method in the case of a data access according to the fourth embodiment.

FIG. 11 is a perspective view of an entire personal computer mounted with an SSD as a memory system according to a fourth embodiment; and

FIG. 12 is a diagram of a system configuration example of the personal computer mounted with the SSD as the memory system according to the fourth embodiment.

### DETAILED DESCRIPTION

In the technology disclosed in Japanese Patent Laid-Open Publication No. 2003-108442, a software vender creates an encryption program by dividing a plain text program into blocks each having a predetermined length and by performing encryption using block-corresponding key varied for each block. The block-corresponding keys are prepared not in accordance with the number of blocks, but a constant Cx which is used as a base for generating the plurality of keys and a key Kx which is used for encrypting a plurality of intermediate values generated based on Cx are prepared as two distribution keys, and the block-corresponding keys are generated from the distribution keys. More specifically, the block-corresponding key is obtained by using the key Kx for encrypting the intermediate value generated based on Cx for each of the blocks. The distribution keys are encrypted by a public key of a processor of a computer as a distribution destination and stored together with the encryption program in a secondary memory device of the distribution destination computer.

In the case where the distribution destination computer executes the encryption program, the processor locates the encryption program from the secondary memory device to a memory, and an address range of an access request of the encryption program is loaded onto a cache memory. Here, the processor performs a processing for generating a block-corresponding key for decryption by using the address of the access request and the constant Cx of the distribution key and then decrypts a block of the encryption program read out from the memory by using the block-corresponding key, thereby storing the block to the cache memory.

As described above, in the method of obtaining the block-corresponding key by a calculation for each of the blocks of the access requests and performing the decryption processing by using the block-corresponding keys, there has been a problem of an increase in latency of memory access which entails a reduction of system response speed.

Hereinafter, exemplary embodiments of a semiconductor memory system will be described in detail with reference to the accompanying drawings. The present invention is not limited to the following embodiments.

The problem of Japanese Patent Laid-Open Publication No. 2003-108442 will be firstly described, and then the present embodiments which solve the problem of Japanese Patent Laid-Open Publication No. 2003-108442 will be described. As described in the foregoing, with the method of Japanese Patent Laid-Open Publication No. 2003-108442, after designation of the range of the encryption program to be accessed by using the address, the processing for generating the block-corresponding key for decrypting the block corresponding to the designated address is performed, and the encryption program is decrypted by using the block-corresponding key.

Therefore, even in the case where an address identical to the previously designated address is designated, for example, it has been necessary to perform the block-corresponding key generation processing for the decryption of the block corresponding to the range of the encryption program to be accessed in order to perform the decryption of the encryption program by using the block-corresponding key. In short, there has been a problem that the time to access the plain text program is delayed by a time period for the processing for generating the block-corresponding key after the address designation.

Also, the processor generally makes a request for data having a data size which is larger than a data size equal to a minimum processable unit of the processor. For example, for the block disclosed in Japanese Patent Laid-Open Publication No. 2003-108442, it is highly probable that the processor makes a request for data having the size for a several blocks. In such case, with the method disclosed in Japanese Patent Laid-Open Publication No. 2003-108442, when an address corresponding to a first block of the encryption program is designated by the processor, a first block-corresponding key corresponding to the first block is generated, and the first block is decrypted by using the first block key to be stored in the cache memory, followed by the same processing for a second block. Since the block-corresponding key generation processing is performed after receiving the access request for each of the blocks even when the access to the data larger than one block is made in the method of Japanese Patent Laid-Open Publication No. 2003-108442, the processor accesses the plain text program after the block-corresponding key generation processing and the decryption processing using the block-corresponding key are performed, thereby raising the problem of consuming time until the processor actually accesses the plain text program after the access request.

Therefore, the present embodiments which are capable of solving the problems of the conventional technology will hereinafter be described.

In general, according to one embodiment, there is provided a semiconductor memory system including a controller and a memory unit. The controller includes a generation unit, an association unit, a retaining unit, an encoding/decoding unit, and a determination unit. The generation unit is configured to generate obfuscation information based on access request information relating to an access request. The association unit is configured to manage association of the obfuscation information with the corresponding access request information. The retaining unit is configured to be capable of retaining the obfuscation information generated by the generation unit. The encoding/decoding unit is configured to perform, by using the obfuscation information, an encoding processing for obfuscating data to be written to the memory unit and a decoding processing for deobfuscating data read out from the memory unit. And the determination unit is configured to determine, upon reception of the access request, whether or not the access request information relating to the access request is managed in the association unit. When the access request information is managed, the encoding/decoding unit performs, without generating the obfuscation information, the encoding processing or the decoding processing by using the obfuscation information retained in the retaining unit. And when the access request information is not managed, the encoding/decoding unit performs, after the generation unit generates obfuscation information based on the access request information, the encoding processing or the decoding processing.

### First Embodiment

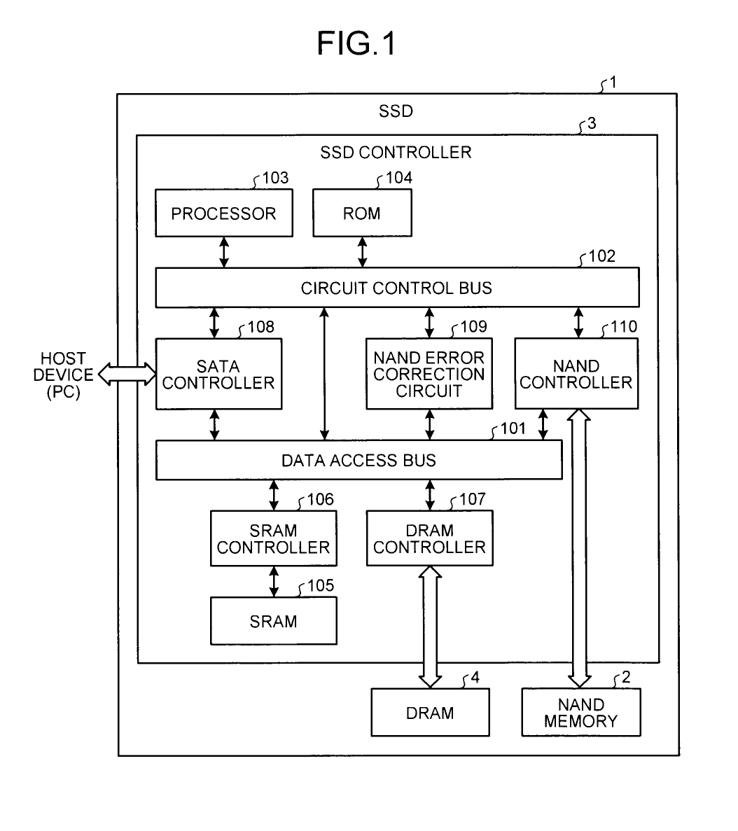

FIG. 1 is a schematic block diagram showing one example of a configuration of a semiconductor memory device. As the semiconductor memory device, an SSD (Solid State Drive) 1 having a NAND type flash memory as a main memory device is exemplified. As shown in FIG. 1, the SSD 1 is connected to a host device such as a personal computer via a communication standard such as a SATA (Serial Advance Technology Attachment) interface to function as an external memory of the host device. The SSD 1 includes a NAND memory 2 which is a nonvolatile memory for storing data of a write request from the host device, an SSD controller 3 serving as a transfer controller for controlling data transfer between the host device and the NAND memory 2, and a DRAM (Dynamic Random Access Memory) 4 which is a volatile memory to be used by the SSD controller 3 as a buffer region for the data transfer.

The SSD controller 3 includes a data access bus 101 and a circuit control bus 102. To the circuit control bus 102, a processor 103 for controlling the entire SSD controller 3 and a ROM (Read Only Memory) 104 in which a boot program for booting management programs (firmware) stored in the NAND memory 2 are connected.

To the data access bus 101, an SRAM (Static RAM) 105 to be used as a data work region and a firmware expansion region is connected via an SRAM controller 106. Upon startup, the firmware stored in the NAND memory 2 is transferred to the SRAM 105 by the boot program stored in the ROM 104 and expanded. The processor 103 controls the entire SSD controller 3 by executing the firmware expanded in the SRAM 105.

Also, a DRAM controller 107 serving as a controller for executing read/write control on the DRAM 4 is connected to the data access bus 101. The DRAM controller 107 detects an error caused before and after a series of DRAM accesses for writing the transfer data to the DRAM 4 and reading the written transfer data and stops use of a region in which the error frequently occurs during the accesses. Also, the DRAM controller 107 performs a decoding processing (processing for deobfuscating) and an encoding processing (processing for executing obfuscation) of secret information that should not be read by an external of the SSD 1 in accordance with instructions from the processor 103. Therefore, the data on which the encoding processing is performed are stored in the DRAM 4.

A SATA interface controller (SATA controller) 108, a NAND error correction circuit 109, and a NAND controller 110 are connected to both of the data access bus 101 and the circuit control bus 102. The SATA controller 108 sends and receives data to and from the host device via the SATA interface.

The NAND controller 110 has an interface function for the NAND memory 2 and an error correction function of correcting an error occurred during access to the NAND memory 2. The error correction function of the NAND controller 110 includes encoding of a second correction code and encoding and decoding of a first error correction code. The NAND error correction circuit 109 performs decoding of the second error correction code. The first error correction code and the second error correction code are, for example, a humming code, a BCH (Bose-Chaudhuri-Hocquenghem) code, an RS (Reed Solomon) code, an LDPC (Low Density Parity Check) code, or the like, and correction capability of the second error correction code is set higher than correction capability of the first error correction code.

Also, the NAND controller 110 may perform a decoding processing (processing for deobfuscating) and an encoding processing (processing for executing obfuscation) on the secret information which should not be read to the external of the SSD 1 in accordance with instructions of the processor 103 in the same manner as in the DRAM controller 107. Therefore, data on which the encoding processing is performed may be stored in the NAND memory 2. The obfuscation processing in the DRAM controller 107 and the obfuscation processing in the NAND controller 110 may be executed based on a common algorithm or based on different algorithms.

In the SSD 1 having the above-described configuration, secret information such as user information is stored in the NAND memory 2 or the DRAM 4 in some cases. For instance, since the NAND memory 2 and the DRAM 4 are mounted in the external of the SSD controller 3 in the present embodiment, the secret information as it is can be leaked to the external of the SSD 1 in the case where no restriction is imposed on an access to the secret information. Therefore, in the present embodiment, the DRAM controller 107 performs the obfuscation processing on data to be written to the DRAM 4 and performs the processing for deobfuscation processing on the data to be loaded onto the processor 103. Hereinafter, the functional unit that performs the obfuscation processing in the DRAM controller 107 will be referred to as obfuscation processing unit. Also, the obfuscation processing is performed at least on the secret information (user information and the like) among data when the secret information is written to the DRAM 4. Likewise, the obfuscation processing may be performed on the secret information when written to the NAND memory 2 in the NAND controller 110.

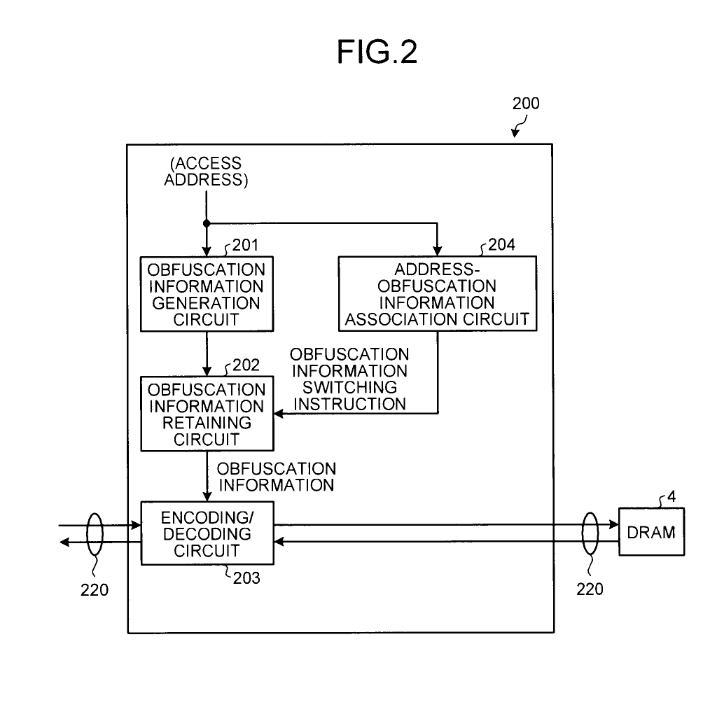

FIG. 2 is a schematic block diagram showing one example of a configuration of an obfuscation processing unit of a controller according to the first embodiment. An obfuscation processing unit 200 has an obfuscation information generation circuit 201, an obfuscation information retaining circuit 202, an encoding/decoding circuit 203, and an address-obfuscation information association circuit 204.

Upon receptions of an access address instructed by the processor 103 and an instruction of obfuscation information generation from the address-obfuscation information association circuit 204, the obfuscation information generation circuit 201 generates obfuscation information which is a key for performing an obfuscation processing (hereinafter referred to as encoding processing) or a deobfuscation processing (hereinafter referred to as decoding processing) based on the access address (access request information). The obfuscation information is random number data generated by using an encoding algorithm such as the conventional AES (Advanced Encryption Standard) by using address information including the access address, for example, as an input. The obfuscation information generation circuit 201 serves as a generation unit.

The obfuscation information retaining circuit 202 retains the obfuscation information generated by the obfuscation information generation circuit 201 after associating the obfuscation information with an address given to a processing unit by which the obfuscation information is used. The obfuscation information retaining circuit 202 outputs one of the retained obfuscation information based on an obfuscation information switching instruction from the address-obfuscation information association circuit 204 described later in this specification. The obfuscation information retaining circuit 202 serves as a retaining unit.

The encoding/decoding circuit 203 is connected to a system bus (data bus) 220 connected to the DRAM 4 and uses the obfuscation information outputted from the obfuscation information retaining circuit 202 for performing the encoding processing on data to be written to the DRAM 4 and performs the decoding processing on data to be read out from the DRAM 4 to the processor 103. For example, in the case of writing data to the DRAM 4, the encoding is performed by calculating an exclusive OR from a plain data string starting from the designated access address and having a predetermined size and the obfuscation information corresponding to the access address in the obfuscation information retaining circuit 202 and writing the encoded data, i.e. obfuscated data, to the DRAM 4. In the case of reading out data in the DRAM 4, the decoding of the obfuscation data is performed by calculating an exclusive OR of an obfuscated data string designated by the access address and having a predetermined size and the obfuscation information corresponding to the access address in the obfuscation information retaining circuit 202 and sending the decoded plain data to the processor 103. The encoding/decoding circuit 203 serves as an encoding/decoding unit.

The address-obfuscation information association circuit 204 manages the obfuscation information by associating the obfuscation information retained in the obfuscation information retaining circuit 202 with the access address which is a base of the obfuscation information. Also, when an access address is inputted from the processor 103 to the obfuscation processing unit 200, the address-obfuscation information association circuit 204 determines whether or not the access address is identical to the address which is the base of the obfuscation information retained in the obfuscation information retaining circuit 202 and, in response to a result of the determination, performs control for generating obfuscation information in the obfuscation information generation circuit 201 or using the obfuscation information retained in the obfuscation information retaining circuit 202. More specifically, in the case where the access address from the processor 103 is the address which is not retained by the obfuscation information retaining circuit 202, the address-obfuscation information association circuit 204 performs the control so that the above-described obfuscation information generation processing is performed by the obfuscation information generation circuit 201. Also, in the case where the access address from the processor 103 is the address retained in the obfuscation information retaining circuit 202, the address-obfuscation information association circuit 204 performs the control so that the obfuscation information generation processing is not performed by the obfuscation information generation circuit 201 and gives an obfuscation information switching instruction to the obfuscation information retaining circuit 202 so that the obfuscation information corresponding to the designated access address is used. The address-obfuscation information association circuit 204 serves as an association unit and a determination unit.

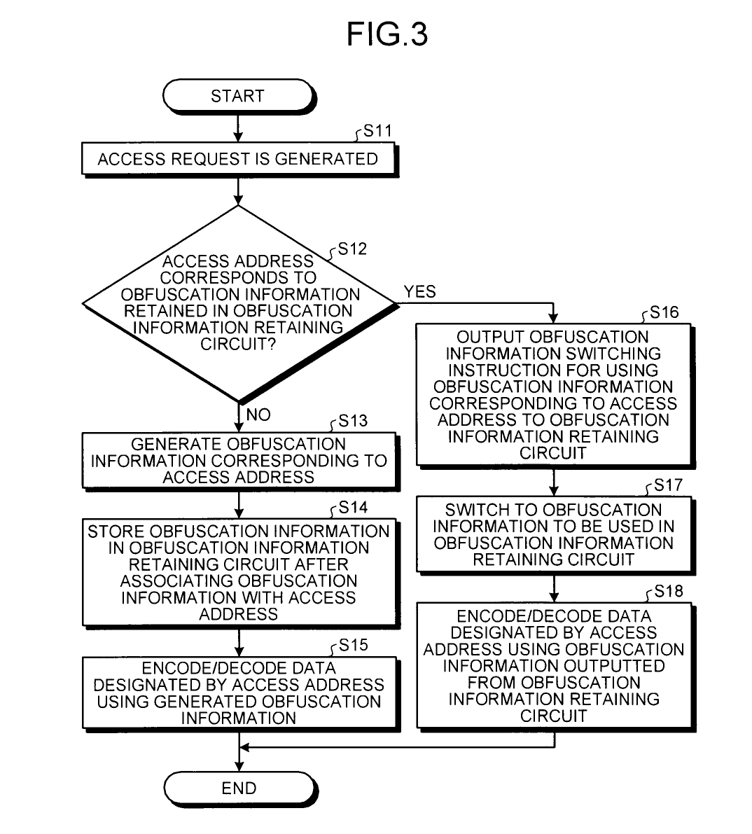

Hereinafter, a control method by the DRAM controller 107 in the case of a data access will be described. FIG. 3 is a flowchart showing one example of the control method according to the first embodiment in the case of a data access. When an access request from the processor 103 to the DRAM 4 is generated (Step S11), the address-obfuscation information association circuit 204 determines whether or not an access address is identical to an address which is a base of obfuscation information retained in the obfuscation information retaining circuit 202 (Step S12). In the present example of the processing, the address-obfuscation information association circuit 204 determines whether or not obfuscation information corresponding to the access address is retained in the obfuscation information retaining circuit 202.

In the case where the obfuscation information corresponding to the access address of the request is not retained in the obfuscation information retaining circuit 202 (No in Step S12), the obfuscation information generation circuit 201 generates obfuscation information by using address information including the access address (Step S13) and stores the generated obfuscation information in the obfuscation information retaining circuit 202 after associating the generated obfuscation information with the access address (Step S14). The obfuscation information and the access address are associated with each other by the address-obfuscation information association circuit 204.

Subsequently, the encoding/decoding circuit 203 performs the encoding/decoding processing on data corresponding to the access address from the processor 103 received from the system bus 220 in Step S11 by using the obfuscation information obtained from the obfuscation information retaining circuit 202 and generated in Step S13 (Step S15). For example, in the case where the data are written from the NAND memory 2 to the DRAM 4, the encoding/decoding circuit 203 encodes the data read out from the NAND memory 2 by using the obfuscation information and writes the data to the DRAM 4. Also, in the case where the data are read out from the DRAM 4 to the processor 103, the encoding/decoding circuit 203 decodes the data stored in the DRAM 4 by using the obfuscation information and sends the data to the processor 103. Thus, the data control processing for the inputted access request is finished.

In contrast, in the case where the obfuscation information corresponding to the access address of the request made in Step S12 is retained in the obfuscation information retaining circuit 202 (Yes in Step S12), the address-obfuscation information association circuit 204 does not allow the obfuscation information generation circuit 201 to perform the obfuscation information generation processing and outputs an obfuscation information switching instruction for switching to the obfuscation information retained in the obfuscation information retaining circuit 202 corresponding to the access address to the obfuscation information retaining circuit 202 (Step S16). Upon reception of the obfuscation information switching instruction, the obfuscation information retaining circuit 202 performs a processing for switching the obfuscation information to be used by the encoding/decoding circuit 203 based on the instruction (Step S17). By the switching processing, the obfuscation information retaining circuit 202, for example, outputs the obfuscation information based on the obfuscation information switching instruction to the encoding/decoding circuit 203. The encoding/decoding circuit 203 encodes/decodes data designated by the access address by using the obfuscation information outputted from the obfuscation information retaining circuit 202 (Step S18). Thus, the control method by the DRAM controller 107 in the case of data access is finished.

As described above, in the case where an access request is generated by using a first access address, for example, first obfuscation information corresponding to the first access address is generated by the obfuscation information generation circuit 201 and associated with the first access address to be retained in the obfuscation information retaining circuit 202, and the encoding/decoding circuit 203 performs the encoding/decoding processing on data identified by the first access address by using the first obfuscation information. In the case where an access request is generated by using a second access address, since obfuscation information corresponding to the second access address is not retained in the obfuscation information retaining circuit 202, second obfuscation information corresponding to the second access address is generated by the obfuscation information generation circuit 201 and associated with the second access address to be retained in the obfuscation information retaining circuit 202, and the encoding/decoding circuit 203 performs the encoding/decoding processing on data identified by the second address by using the second obfuscation information. Subsequently, in the case where an access request is generated by using the first access address again, since the first obfuscation information corresponding to the first access address is retained, the address-obfuscation information association circuit 204 gives an obfuscation information switching instruction for using the first obfuscation information to the obfuscation information retaining circuit 202. The encoding/decoding circuit 203 performs the encoding/decoding processing by using the first obfuscation information in the obfuscation information retaining circuit 202.

As described above, in the case where the access request having the same access address as that of the address of the previous access is generated, the encoding/decoding processing is performed by using the previously generated obfuscation information. Therefore, it is unnecessary to perform the processing for generating the obfuscation information corresponding to the access address for which the access request is generated. A time period for which the obfuscation information once generated is retained may be arbitrarily decided. For example, only the obfuscation information generated by the most recent access may be retained, or the obfuscation information generated by the second most recent access or a more previous access may be retained.

According to the first embodiment, the obfuscation information is generated in the obfuscation information generation circuit 201 by using information including the access address inputted from the processor 103, and then the obfuscation information is associated with the access address to be retained in the obfuscation information retaining circuit 202. Therefore, in the case where an access to the same access address occurs, it is possible to perform the encoding/decoding processing by using the obfuscation information stored in the obfuscation information retaining circuit 202 without generating obfuscation information again in the obfuscation information generation circuit 201. As a result, an effect of reducing an access time to the DRAM 4, which is reduced by eliminating the generation of obfuscation information, is attained as compared to the case of generating the obfuscation information every time the access address is received.

### Second Embodiment

The reduction in access time for accessing the DRAM in the case where the access is made to the identical access address is conducted in the first embodiment, and a case of reducing an access time for accessing the DRAM in a burst access will be described in the second embodiment.

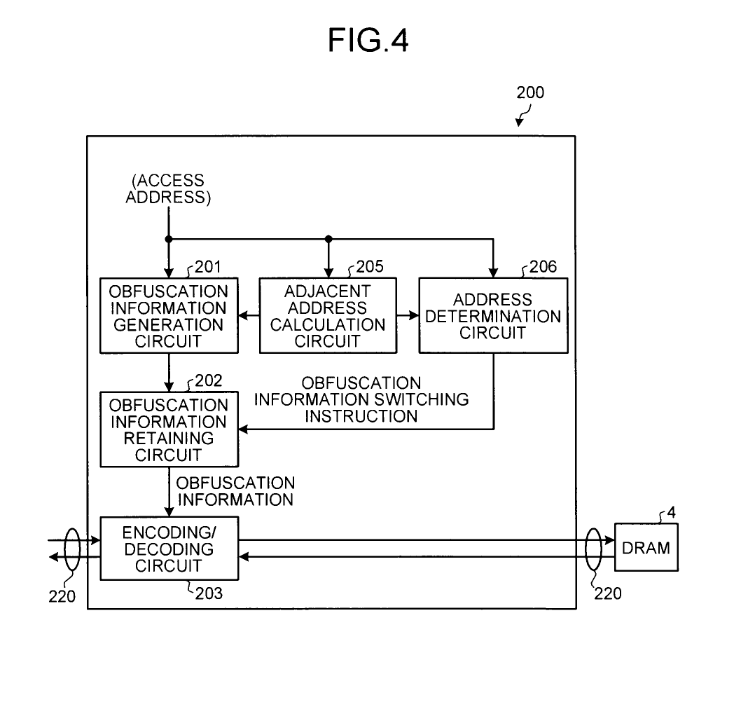

FIG. 4 is a schematic block diagram showing one example of a configuration of an obfuscation processing unit of a controller according to the second embodiment. The obfuscation processing unit 200 includes an obfuscation information generation circuit 201, an obfuscation information retaining circuit 202, an encoding/decoding circuit 203, an adjacent address calculation circuit 205, and an address determination circuit 206.

Upon receptions of an access address inputted from the processor 103 and an instruction of obfuscation information generation from the address determination circuit 206, or upon input of an adjacent address from the adjacent address calculation circuit 205, the obfuscation information generation circuit 201 generates obfuscation information based on the access address (access request information) including the inputted address. In the case where there is an adjacent address input by the adjacent address calculation circuit 205, obfuscation information generated corresponding to the adjacent address is retained until another address input. The obfuscation information generation circuit 201 serves as a generation unit.

Upon input of an access address to the obfuscation processing unit 200, the adjacent address calculation circuit 205 calculates an address adjacent to the inputted access address. Here, under the assumption that the access address is inputted by a minimum unit which is processable by the processor 103, the adjacent address is defined as an address which is obtained by adding a data quantity for the minimum unit processable by the processor 103 to the access address and/or an address which is obtained by subtracting the data quantity for the minimum unit processable by the processor 103 from the access address. In short, the adjacent address calculation circuit 205 calculates the address which is obtained by adding the data quantity for the minimum unit processable by the processor 103 to the access address and/or the address which is obtained by subtracting the data quantity for the minimum unit processable by the processor 103 from the access address as the adjacent address(es). The calculated adjacent address is outputted to the obfuscation information generation circuit 201. Here, only the address which is obtained by adding the data quantity for the minimum unit processable by the processor 103 to the inputted access address is calculated as the adjacent address. The adjacent address calculation circuit 205 serves as a calculation unit.

The address determination circuit 206 determines whether or not the access address inputted to the obfuscation processing unit 200 is identical to the adjacent address which is calculated by the adjacent address calculation circuit 205 when the access address was previously inputted to the obfuscation processing unit 200, and controls the obfuscation information generation circuit 201 and the obfuscation information retaining circuit 202 in accordance with the determination result. More specifically, in the case where the access address inputted to the obfuscation processing unit 200 is not identical to the adjacent address which is calculated by the adjacent calculation circuit 205 with respect to the access address previously inputted to the obfuscation processing unit 200, the address determination circuit 206 instructs the obfuscation information generation circuit 201 to generate obfuscation information corresponding to the access address. In the case where the access address is identical to the adjacent address, the address determination circuit 206 outputs an obfuscation information switching instruction for using the retained obfuscation information corresponding to the adjacent address to the obfuscation information retaining circuit 202 and controls the obfuscation information generation circuit 201 so as not to perform a processing for generating obfuscation information using the inputted access address. The address determination circuit 206 serves as a determination unit.

Since the obfuscation information retaining circuit 202 and the encoding/decoding circuit 203 are the same as those of the first embodiment, description for the circuits is not repeated.

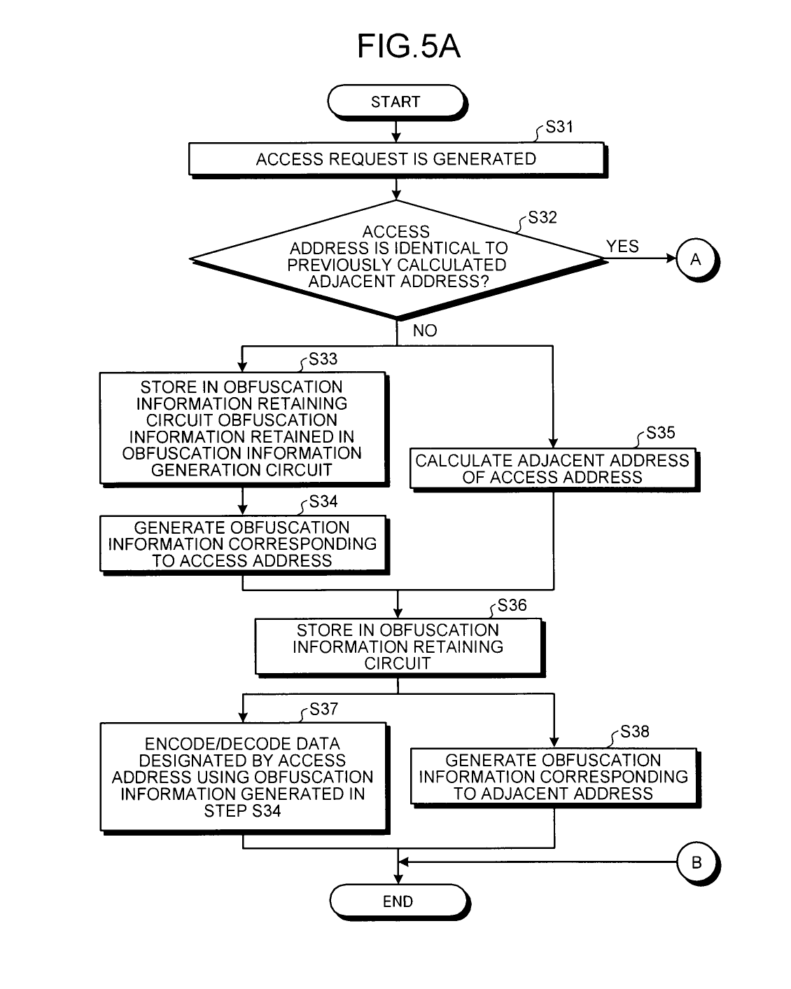

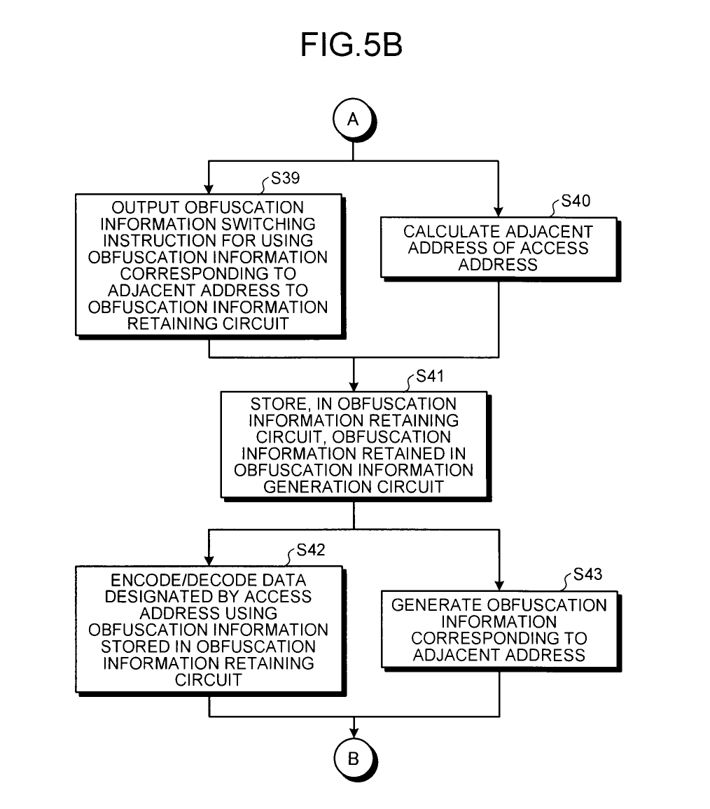

Hereinafter, a control method by a DRAM controller 107 in the case of a data access will be described. FIGS. 5A and 5B are flowcharts showing one example of the control method in the case of a data access according to the second embodiment. When an access request from the processor 103 to the DRAM 4 is generated (Step S31), the address determination circuit 206 determines whether or not the adjacent address calculated by the adjacent address calculation circuit 205 and the access address of the request are identical to each other (Step S32).

In the case where the access address of the request is not identical to the previously calculated adjacent address (No in Step S32), the obfuscation information generation circuit 201 stores the obfuscation information retaining at the time in the obfuscation information retaining circuit 202 (Step S33) and generates obfuscation information based on address information including the inputted access address (Step S34). In parallel to the processing of Steps S33 to S34, the adjacent address calculation circuit 205 calculates an adjacent address which is adjacent to the inputted access address (Step S35) and outputs the calculated adjacent address to the obfuscation information generation circuit 201. Subsequently, the obfuscation information generation circuit 201 to which the adjacent address is inputted stores the obfuscation information generated in Step S34 in the obfuscation information retaining circuit 202 (Step S36). Thus, the obfuscation information generated when the previous access request was made (the obfuscation information retained in the obfuscation information retaining circuit 202 in Step S33) is deleted.

Subsequently, the encoding/decoding circuit 203 uses the obfuscation information obtained from the obfuscation information retaining circuit 202 (generated in Step S34) to perform the processing for encoding/decoding data corresponding to the access address received from the processor 103 via the system bus 220 in Step S31 (Step S37). Also, in parallel to the encoding/decoding processing in Step S37, the obfuscation information generation circuit 201 generates obfuscation information corresponding to the calculated adjacent address (Step S38). Thus, the data control processing for the inputted access request is finished.

In contrast, in the case where the access address of the request made in Step S32 is identical to the previously calculated adjacent address (Yes in Step S32), the address determination circuit 206 does not allow the obfuscation information generation circuit 201 to generate obfuscation information corresponding to the inputted access address and outputs an obfuscation information switching instruction for using the obfuscation information which is retained in the obfuscation information generation circuit 201 corresponding to the adjacent address for the encoding/decoding processing to the obfuscation information retaining circuit 202 (Step S39).

Also, in parallel to the processing in Step S39, the adjacent address calculation circuit 205 calculates an adjacent address which is adjacent to the inputted access address (Step S40) and outputs the calculated adjacent address to the obfuscation information generation circuit 201. Upon input of the adjacent address, the obfuscation information generation circuit 201 stores the retained obfuscation information in the obfuscation information retaining circuit 202 (Step S41). By the above-described processing, the data retained in the obfuscation information retaining circuit 202, for example, are discarded, and, in place of the discarded data, the obfuscation information which is retained in the obfuscation information generation circuit 201 corresponding to the adjacent address is stored in the obfuscation information retaining circuit 202.

Subsequently, the encoding/decoding circuit 203 uses the obfuscation information retained in the obfuscation information retaining circuit 202 (obfuscation information generated when the previous access request was made) to perform the encoding/decoding processing on the data designated by the access address (Step S42). Also, in parallel to the processing in Step S42, the obfuscation information generation circuit 201 generates obfuscation information corresponding to the adjacent address calculated in Step S40 (Step S43). Thus, the data control processing for the inputted access request is finished.

Thus, the second address which is adjacent to the first access address is calculated simultaneously with the generation of the first obfuscation information for the initial first access address, and the second obfuscation information corresponding to the second address is generated. After the encoding/decoding processing on the data corresponding to the first access address is performed by using the first obfuscation information, the access request is made by using the second access address. In the case where a burst access which is an access to data larger than the minimum processable unit performed by the processor 103 from the NAND memory 2 is generated, an access request to the second access address which is adjacent to the first address is generated after an access request to the first access address. Here, since the second access address is the same as the second address which has already been calculated, a state in which the second obfuscation information has already been generated occurs. In short, the obfuscation information circuit 201 does not generate obfuscation information corresponding to the second access address after the access request using the second access address is made, and it is possible for the encoding/decoding circuit 203 to perform the encoding/decoding processing by using the second obfuscation information corresponding to the already generated second address.

According to the second embodiment, when the initial access address is inputted to the DRAM controller 107, the adjacent address which is adjacent to the access address is calculated, and the obfuscation information corresponding to the adjacent address is generated. Therefore, in the case where the burst access occurs, since the obfuscation information corresponding to the adjacent address which is adjacent to the initially inputted access address has been generated, it is unnecessary to generate obfuscation information upon input of a next access address, thereby making it possible to access the data on the DRAM 4 by using the already generated obfuscation information. As a result, an effect of large reduction in time is attained as compared to the case of generating obfuscation information based on a next access address after input of the next access address and performing the encoding/decoding processing.

Though the example of calculating only the address obtained by adding the data quantity for the minimum unit processable by the processor 103 to the inputted access address as the adjacent address is described in the above description, only the access address obtained by subtracting the minimum unit processable by the processor 103 from the inputted access address may be calculated.

Also, two adjacent addresses including the access address obtained by adding the data quantity for the minimum unit processable by the processor 103 to the inputted access address and the access address obtained by subtracting the minimum unit processable by the processor 103 from the inputted access address may be calculated. In this case, the obfuscation information retaining circuit 202 may have a configuration of being capable of retaining a plurality of obfuscating information with access addresses/adjacent addresses, and the address determination circuit 206 may have a configuration of further including a function of managing the obfuscation information retained in the obfuscation information retaining circuit 202 by associating the obfuscation information with the address which is the base of the obfuscation information. With such configuration, in the case here the access address is identical to the previously calculated adjacent address, the address determination circuit 206 may output an obfuscation information switching instruction to the obfuscation information retaining circuit 202 to switch to the obfuscation information retained as being associated with the adjacent address.

### Third Embodiment

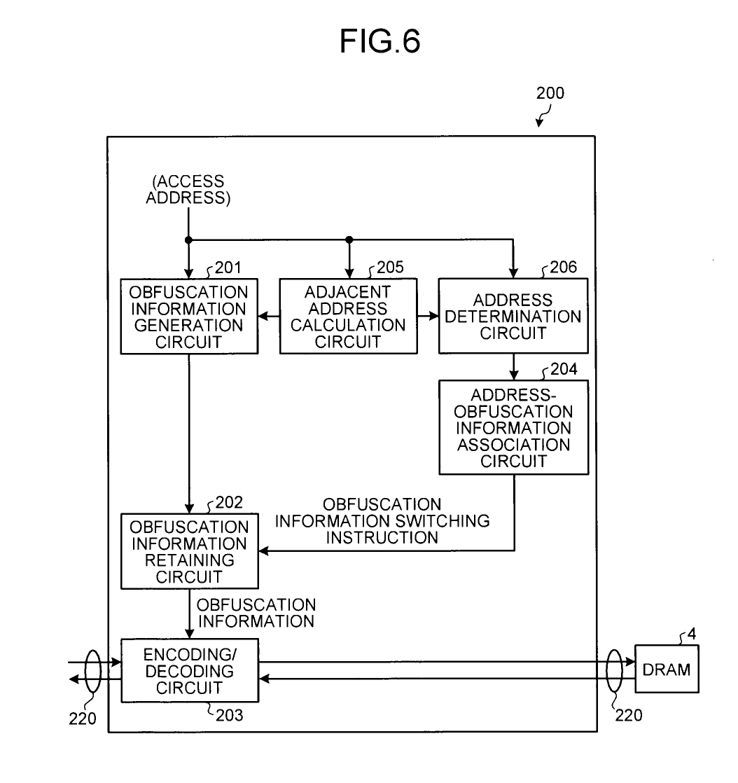

In the third embodiment, an obfuscation processing unit as a combination of the first embodiment and the second embodiment will be described. FIG. 6 is a schematic block diagram showing one example of a configuration of the obfuscation processing unit of a controller according to the third embodiment. The obfuscation processing unit 200 includes an obfuscation information generation circuit 201, an obfuscation information retaining circuit 202, an encoding/decoding circuit 203, an address-obfuscation information association circuit 204, an adjacent address calculation circuit 205, and an address determination circuit 206.

Upon receptions of an access address inputted from the processor 103 and an instruction of obfuscation information generation from the address determination circuit 206, or upon input of an adjacent address from the adjacent address calculation circuit 205, the obfuscation information generation circuit 201 generates obfuscation information based on address information (access request information) including the inputted address. The obfuscation information generation circuit 201 serves as a generation unit.

The obfuscation information retaining circuit 202 retains obfuscation information generated by the obfuscation information generation circuit 201 after associating the obfuscation information with an address (access address/adjacent address) which is a base for the obfuscation information. Here, at least the obfuscation information once accessed and the obfuscation information of the adjacent address of the previously accessed access address are retained. The obfuscation information retaining circuit 202 serves as a retaining unit.

Upon input of an access address from the processor 103, the address determination circuit 206 determines whether or not the access address is identical to the adjacent address which is adjacent to the previously inputted access address or whether or not the access address is identical to the address which is the base for the obfuscation information retained in the obfuscation information retaining circuit 202 and controls the obfuscation information generation circuit 201 in accordance to the determination result. In the case where the access address is identical to the adjacent address or the address corresponding to the obfuscation information retained in the obfuscation information retaining circuit 202, the address determination circuit 206 outputs the identical address (access address) to the address-obfuscation information association circuit 204 and controls the obfuscation information generation circuit 201 so as not to generate obfuscation information. Also, in the case where the access address is not identical to the adjacent address or the address corresponding to the obfuscation information retained in the obfuscation information retaining circuit 202, the address determination circuit 206 controls the obfuscation information generation circuit 201 so as to generate obfuscation information corresponding to the access address inputted to the obfuscation information generation circuit 201. The address determination circuit 206 serves as a determination unit.

The address-obfuscation information association circuit 204 manages the obfuscation information retained in the obfuscation information retaining circuit 202 by associating the obfuscation information with the access address or the adjacent address and, when an address is inputted from the address determination circuit 206, outputs an obfuscation information switching instruction to the obfuscation information retaining circuit 202 for switching to the obfuscation information retained as being associated with the address (the access address or the adjacent address). The address-obfuscation information association circuit 204 serves as an association unit and a determination unit.

Since the encoding/decoding circuit 203 and the adjacent address calculation circuit 205 are the same as those of the first and the second embodiments, description for the circuits is not repeated.

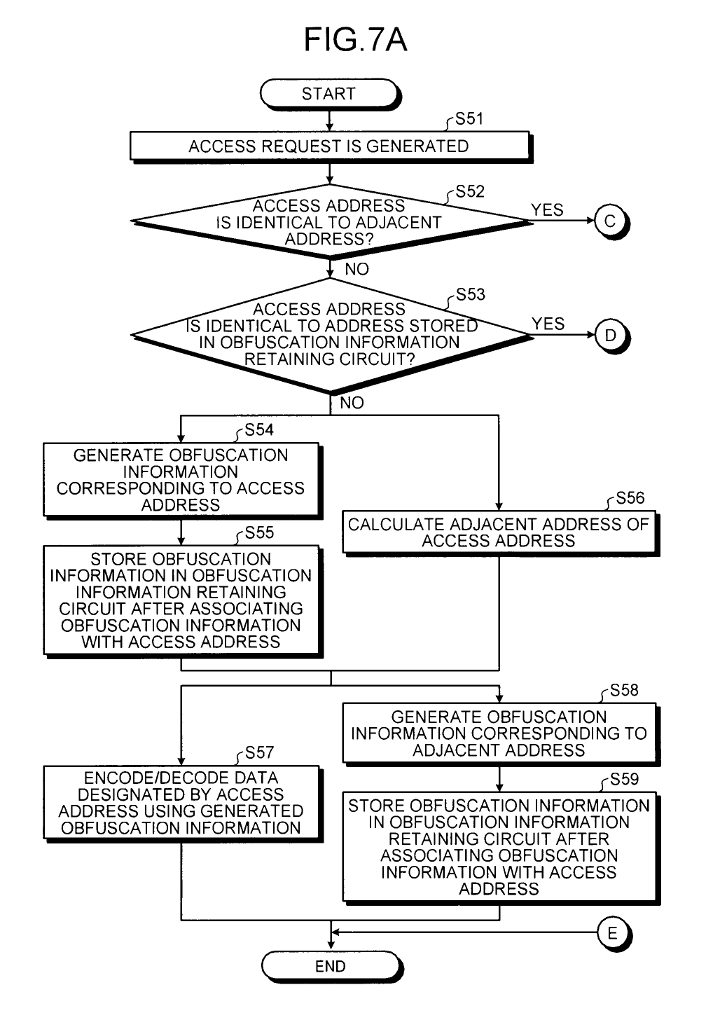

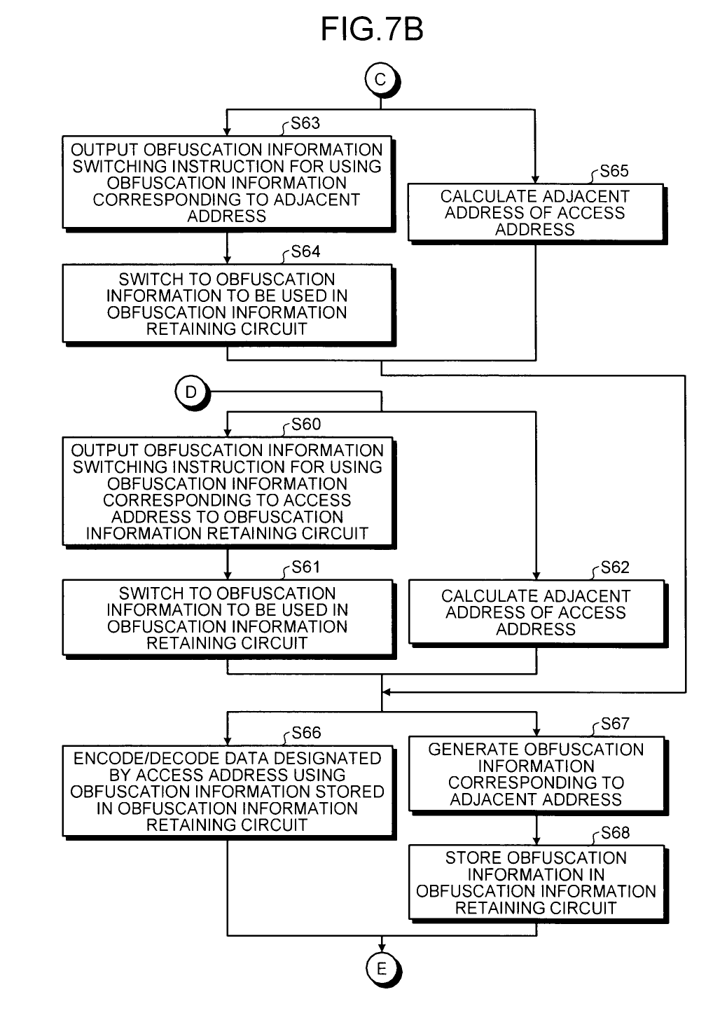

Hereinafter, a control method by a DRAM controller 107 in the case of a data access will be described. FIGS. 7A and 7B are flowcharts showing one example of the control method in the case of a data access according to the third embodiment. When an access request to the DRAM 4 from the processor 103 is generated (Step S51), the address determination circuit 206 determines whether or not the adjacent address calculated by the adjacent address calculation circuit 205 in a previous access request and the access address of the request are identical to each other (Step S52).

In the case where the access address of the request is not identical to the previously calculated adjacent address (No in Step S52), the address determination circuit 206 determines whether or not the access address is identical to the address associated with the obfuscation information retained in the obfuscation information retaining circuit 202 (Step S53).

In the case where the access address is not identical to the address associated with the obfuscation information retained in the obfuscation information retaining circuit 202 (No in Step S53), the address determination circuit 206 instructs the obfuscation information generation circuit 201 to generate obfuscation information, and the obfuscation information generation circuit 201 generates obfuscation information based on the access address (Step S54) to store the obfuscation information in the obfuscation information retaining circuit 202 after associating the obfuscation information with the access address (Step S55). In parallel to the processing of Steps S54 to S55, the adjacent address calculation circuit 205 calculates an adjacent address which is adjacent to the inputted access address (Step S56).

Subsequently, the encoding/decoding circuit 203 uses the obfuscation information obtained from the obfuscation information retaining circuit 202 (obfuscation information generated in Step S54) to perform an encoding/decoding processing on the data (Step S57). The data encoding/decoding processing is the same as that described in the first embodiment. Also, in parallel to the encoding/decoding processing in Step S57, the obfuscation information generation circuit 201 generates obfuscation information corresponding to the calculated adjacent address in Step S56 (Step S58) and stores the obfuscation information in the obfuscation information retaining circuit 202 after associating the obfuscation information with the adjacent address (Step S59). Thus, the control method by the DRAM controller 107 in the case of a data access is finished.

In contrast, in the case where the access address in Step S53 is identical to the address associated with the obfuscation information retained in the obfuscation information retaining circuit 202 (Yes in Step S53), the address determination circuit 206 does not allow the obfuscation information generation circuit 201 to generate obfuscation information corresponding to the inputted access address and outputs the access address to the address-obfuscation information association circuit 204. The address-obfuscation information association circuit 204 outputs an obfuscation information switching instruction for switching to the obfuscation information corresponding to the inputted access address to the obfuscation information retaining circuit 202 (Step S60). The obfuscation information retaining circuit 202 switches to the obfuscation information to be used based on the obfuscation information switching instruction (Step S61). Also, in parallel to the processing of Step S60 to S61, the adjacent address calculation circuit 205 calculates an adjacent address of the access address (Step S62) and outputs the result to the obfuscation information generation circuit 201.

In the case where the access address in Step S52 is identical to the adjacent address (Yes in Step S52), the address determination circuit 206 does not allow the obfuscation information generation circuit 201 to generate obfuscation information and outputs the access address to the address-obfuscation information association circuit 204. Upon reception of the access address, the address-obfuscation information association circuit 204 outputs an obfuscation information switching instruction for switching to the obfuscation information corresponding to the access address (adjacent address) to the obfuscation information retaining circuit 202 (Step S63). Subsequently, the obfuscation information retaining circuit 202 switches to the obfuscation information to be used by the encoding/decoding circuit 203 based on the obfuscation information switching instruction (Step S64). In parallel to the processing of S63 to S64, the adjacent address calculation circuit 205 calculates an adjacent address of the inputted access address (Step S65).

Subsequently or after the Steps S61 and S62, the encoding/decoding circuit 203 uses the obfuscation information stored in the obfuscation information retaining circuit 202 to perform a data encoding/decoding processing (Step S66). Also, in parallel to the processing of Step S66, the obfuscation information generation circuit 201 generates obfuscation information corresponding to the adjacent address generated in Step S62 or Step S65 (Step S67) and stores the obfuscation information in the obfuscation information retaining circuit 202 after associating the obfuscation information with the adjacent address (Step S68). Thus, the control method by the DRAM controller 107 in the case of a data access is finished.

According to the third embodiment, since the obfuscation information corresponding to the previously accessed address is retained, it is possible to perform the encoding/decoding processing without generating the obfuscation information in the case where an access is made to the address again. Also, since the obfuscation information corresponding to an adjacent address to the accessed address is generated and retained, it is possible to reduce a response time even in the case where a burst access occurs due to the obfuscation information which has already been made for the address before the address is designated.

The access address is not particularly specified in the first to the third embodiments, but the access address may be a logical address designated by the processor 103 in the SSD controller 3 or may be a physical address of the DRAM 4. In the case where the access address is the physical address of the DRAM 4, the logical address may be converted into the physical address by the processor 103 or the DRAM controller 107 by using a management table for associating the logical address managed by the processor 103 with the physical address in the DRAM 4, for example.

### Fourth Embodiment

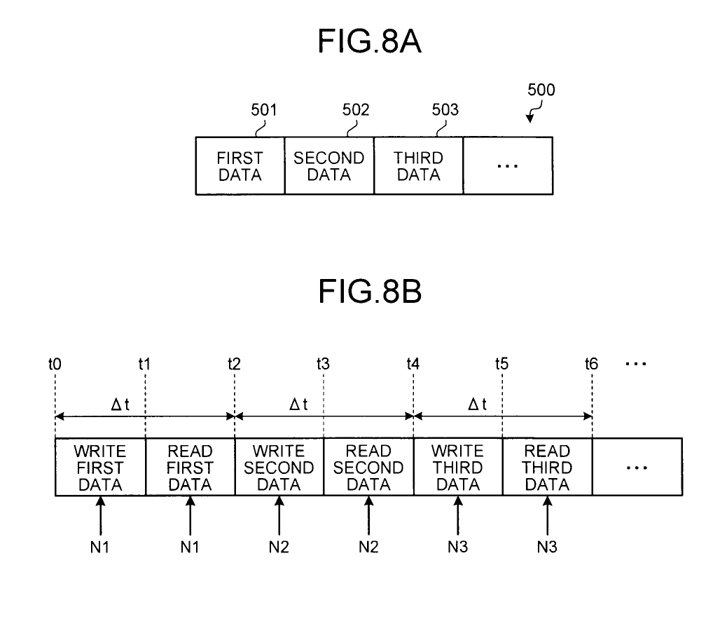

In the fourth embodiment, a case of speeding up a data obfuscation processing or a data deobfuscation processing in the case where accesses are generated at predetermined intervals. FIGS. 8A and 8B are diagrams showing one example of a case in which data writing and reading are generated at predetermined intervals. For example, a case of reading out data 500 which are larger than a minimum unit processable by a processor 103 will be considered. The data 500 are formed of first data 501, second data 502, third data 503, and the like as shown in FIG. 8A, each of which has the size of the minimum unit (hereinafter also referred to as an access unit) processable by the processor 103 and stored in the NAND memory 2.

In the case where the data 500 are read out to an external device from the NAND memory 2, the data 500 are temporarily stored in the DRAM 4 and then read out by the processor 103 from the DRAM 4. In this case, a processing for obfuscating and writing the data 501, 502, 503, and the like to the DRAM 4 by the access unit and a processing for forming the obfuscated data 501, 502, 503, and the like in the DRAM 4 into plain texts by the access unit and reading out the plain texts are performed on a predetermined cycle. In other words, as shown in FIG. 8B, the processings in which the first data 501 among the original data 500 are subjected to an encoding processing by using obfuscation information N1 to be written to the DRAM 4 at time t0 and subjected to a decoding processing by using the obfuscation information N1 to be read out from the DRAM 4 at time t1; the second data 502 among the original data 500 are subjected to an encoding processing by using obfuscation information N2 to be written to the DRAM 4 at time t2 which is after the time t0 by Δt and subjected to a decoding processing by using the obfuscation information N2 to be read out from the DRAM 4 at time t3; and the third data 503 among the original data 500 are subjected to an encoding processing by using obfuscation information N3 to be written to the DRAM 4 at time t4 which is after the time t2 by Δt and subjected to a decoding processing by using the obfuscation information N3 to be read out from the DRAM 4 at time t5 are repeatedly executed as described above at the predetermined time interval of Δt.

In the case where the writing to and reading from the DRAM 4 occur on the predetermined cycle as described above, it is possible to generate obfuscation information based not only on the access address as described in the first to the third embodiments but also on an access time. Accordingly, in the fourth embodiment, a controller for performing an obfuscation processing in the case where a burst access occurs to cyclically cause writing to and reading from the DRAM 4 as shown in FIGS. 8A and 8B as well as a control method for the same will be described.

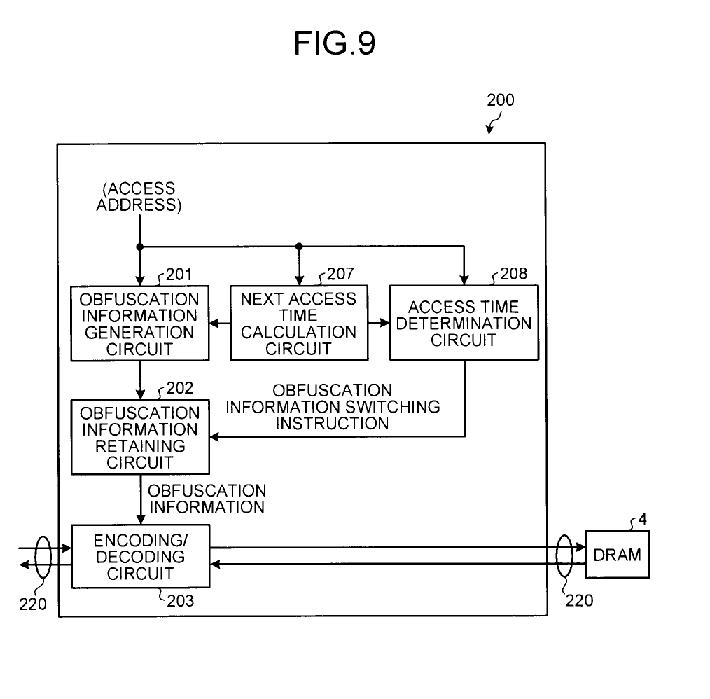

FIG. 9 is a schematic block diagram showing one example of a configuration of an obfuscation processing unit of a controller according to the fourth embodiment. The obfuscation processing unit 200 includes an obfuscation information generation circuit 201, an obfuscation information retaining circuit 202, an encoding/decoding circuit 203, a next access time calculation circuit 207, and an access time determination circuit 208.

Upon reception of an access from the processor 103 and an instruction of obfuscation information generation by the access time determination circuit 208, the obfuscation information generation circuit 201 generates obfuscation information based on time information (access request information) including an access time. Also, upon input of a next access time from the next access time calculation circuit 207, the obfuscation information generation circuit 201 generates obfuscation information based on time information including the next access time. The obfuscation information generated based on the next access time is generated in advance of the access time of the subsequent access request. In the case where the next access time is inputted from the next access time calculation circuit 207, the obfuscation information generated corresponding to the next access time is retained until the subsequent access time information is inputted. The obfuscation information generation circuit 201 serves as a generation unit.

Upon input of the access request from the processor 103, the next access time calculation circuit 207 calculates the next access time which is subsequent to the access time. It is possible to calculate the next access time by adding the initial access time to the time Δt required for writing and reading the data by the access unit from the NAND memory 2 to the DRAM 4. The calculated next access time is outputted to the obfuscation information generation circuit 201 and the access time determination circuit 208. The next access time calculation circuit 207 serves as a calculation unit.

Based on the access time of the initial access, the access time determination circuit 208 determines whether or not the access time of the subsequent access request is the next access time which is preliminarily calculated in the previous access request by the next access time calculation circuit 207. The access time determination circuit 208 instructs the obfuscation information generation circuit 201 to generate obfuscation information in the case where the access time of the subsequent access is not the next access time calculated by the next access time calculation circuit 207. And the access time determination circuit 208 does not allow the obfuscation information generation circuit 201 to generate obfuscation information and outputs an obfuscation information switching instruction for using the preliminarily generated obfuscation information retained in the obfuscation information retaining circuit 202 to the obfuscation information retaining circuit 202 in the case where the access time of the subsequent access is the next access time calculated by the next access time calculation circuit 207. The access time determination circuit 208 serves as a determination unit.

The obfuscation information retaining circuit 202 is the same as that of the second embodiment, and the encoding/decoding circuit 203 is the same as that of the first embodiment. Accordingly, description for the circuits is not repeated.

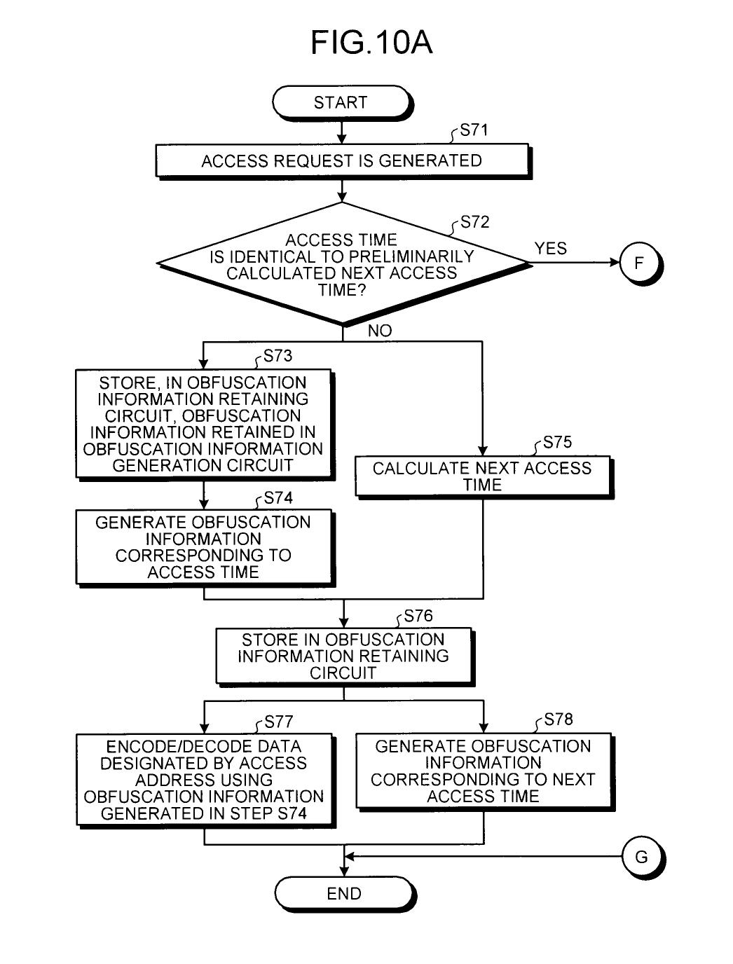

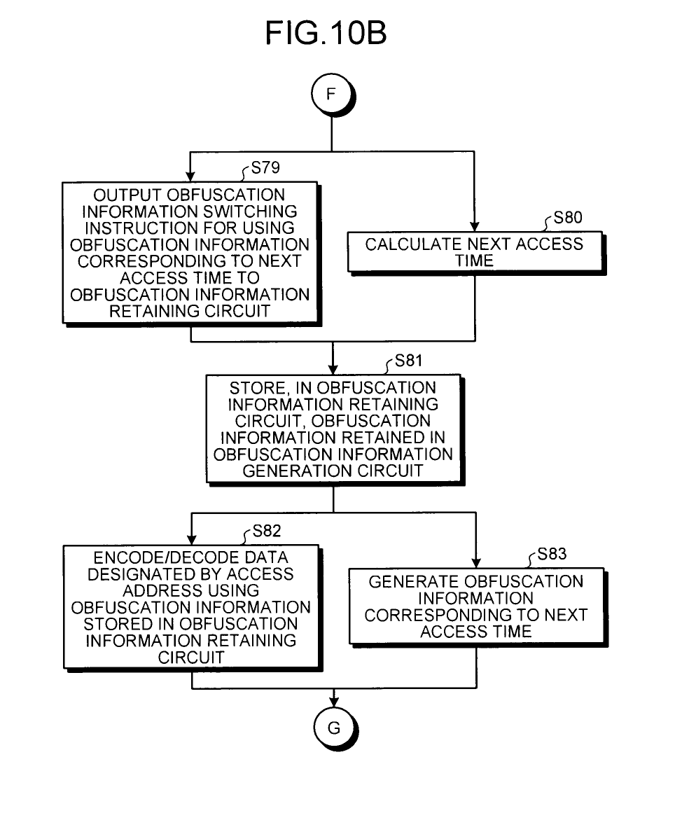

Hereinafter, a control method by the DRAM controller 107 in the case of a data access will be described. FIGS. 10A and 10B are flowcharts showing one example of the control method in the case of a data access according to the fourth embodiment. When an access request from the processor 103 to the DRAM 4 is generated (Step S71), the access time determination circuit 208 determines whether or not an access time is identical to a next access time which is calculated by the next access time calculation circuit 207 in an access request previous to the access request of Step 71 (Step S72).

In the case where the access time is not identical to the previously calculated next access time (No in Step S72), the obfuscation information generation circuit 201 stores obfuscation information retained therein in the obfuscation information retaining circuit 202 (Step S73) and generates obfuscation information based on time information including the access time of the inputted access request (Step S74). In parallel to the processing of Steps S73 to S74, the next access time calculation circuit 207 calculates a next access time of an access request that is expected to follow the inputted access request (Step S75) and outputs the calculated next access time to the obfuscation information generation circuit 201. Subsequently, the obfuscation information generation circuit 201 to which the next access time is inputted stores the obfuscation information generated in Step S74 to the obfuscation information retaining circuit 202 (Step S76). Thus, the obfuscation information generated in the previous access request (obfuscation information retained in the obfuscation information retaining circuit 202 in Step S73) is deleted.

Subsequently, the encoding/decoding circuit 203 uses the obfuscation information obtained from the obfuscation information retaining circuit 202 (obfuscation information generated in Step S74) to perform a processing of encoding/decoding data corresponding to the access request in Step S71 received from the processor 103 via the system bus 220 (Step S77). Also, in parallel to the encoding/decoding processing in Step S77, the obfuscation information generation circuit 201 generates obfuscation information corresponding to the calculated next access time (Step S78). Thus, the data control processing for the inputted access request is finished.

In contrast, in the case where the access time of the access request in Step S72 is identical to the calculated next access time (Yes in S72), the access time determination circuit 208 does not allow the obfuscation information generation circuit 201 to generate obfuscation information corresponding to the access time (next access time) of the inputted access request and outputs an obfuscation information switching instruction for using the obfuscation information retained corresponding to the next access time in the obfuscation information generation circuit 201 for the encoding/decoding processing to the obfuscation information retaining circuit 202 (Step S79).

Also, in parallel to the processing in Step S79, the next access time calculation circuit 207 calculates a next access time of an access request that is expected to be inputted subsequent to the access request (Step S80) and outputs the calculated next access time to the obfuscation information generation circuit 201. The obfuscation information generation circuit 201 to which the next access time is inputted stores the obfuscation information retained therein in the obfuscation information retaining circuit 202 (Step S81). By the above-described processing, the data retained in the obfuscation information retaining circuit 202 is discarded, for example, and, in place of the discarded data, the obfuscation information corresponding to the next access time retained in the obfuscation information generation circuit 201 is stored in the obfuscation information retaining circuit 202.

Subsequently, the encoding/decoding circuit 203 performs an encoding/decoding processing on data designated by the access address by using the obfuscation information stored in the obfuscation information retaining circuit 202 (Step S82). Also, in parallel to the processing in Step S82, the obfuscation information generation circuit 201 generates obfuscation information corresponding to the next access time calculated in Step S80 (Step S83). Thus, the data control processing for the inputted access request is finished.

According to the above-described configuration, the obfuscation information is generated based on the access time of the access request from the processor 103, and, also, the next access time obtained by adding the predetermined time to the access time and the obfuscation information based on the next access time are generated. Therefore, in the case where the initial access is the burst access, since the processings for writing to and reading from the DRAM 4 are performed at the predetermined cycle, it is possible to reduce the time elapsed from the access request to the data access as compared to the case of generating obfuscation information at the access time of the next access request.

According to the fourth embodiment, in the case of performing the writing to and reading from the DRAM 4 at the predetermined cycle, the next access time is calculated from the access time of the initial access, and the obfuscation information is generated based on the next access time to be retained. Therefore, in the case of the burst access, since the obfuscation information is already generated before the next access instruction is given, it is possible to omit the time required for generating the obfuscation information as compared to the case of generating obfuscation information after the next access request is inputted and based on the access time of the next access request, thereby attaining an effect of providing a memory system with which the time required for obfuscation may not cause any problem.

The SSD 1 including the NAND memory 2 and the DRAM 4 is exemplified in the foregoing description, but the present invention is not limited to this. The present embodiments are applicable to general semiconductor memory devices including a first memory unit for storing secret information in a nonvolatile manner and a second memory unit for temporarily storing data stored in the first memory unit by an instruction from a host device, in which the data stored in the second memory unit are obfuscated.

The data to be obfuscated may be the entire data stored in the first memory unit or may be a part of the data stored in the first memory unit. In such cases, data stored in a predetermined address range of the first memory unit, for example, are subjected to the obfuscation processing when expanded to the second memory unit, and the data stored in the rest of the address range may not be subjected to the obfuscation processing when expanded to the second memory unit.

### Fifth Embodiment

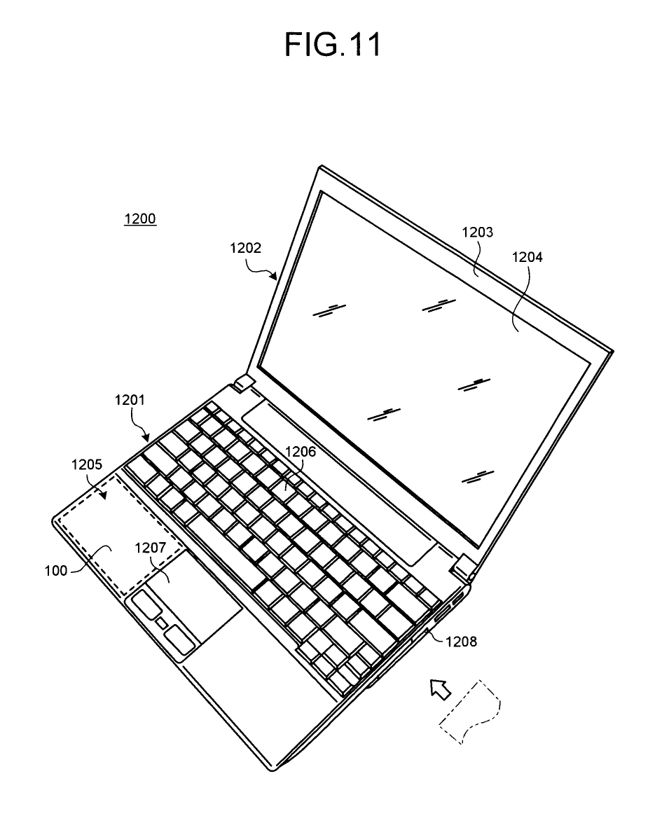

FIG. 11 is a perspective view of an example of a personal computer 1200 mounted with a solid state drive (SSD) 100 according to a fourth embodiment. The SSD 100 is, for example, the memory system explained in the first to third embodiments.

The personal computer 1200 includes a main body 1201 and a display unit 1202. The display unit 1202 includes a display housing 1203 and a display device 1204 housed in the display housing 1203.

The main body 1201 includes a housing 1205, a keyboard 1206, and a touch pad 1207 as a pointing device. A main circuit board, an optical disk device (ODD) unit, a card slot, the SSD 100, and the like are housed on the inside of the housing 1205.

The card slot is provided adjacent to a peripheral wall of the housing 1205. An opening 1208 opposed to the card slot is provided in the peripheral wall. A user can insert an additional device into and remove the additional device from the card slot from the outside of the housing 1205 through the opening 1208.

The SSD 100 can also be used while being mounted on the inside of the personal computer 1200 as a replacement of the HDD in the pastor can also be used as an additional device while being inserted into the card slot included in the personal computer 1200.

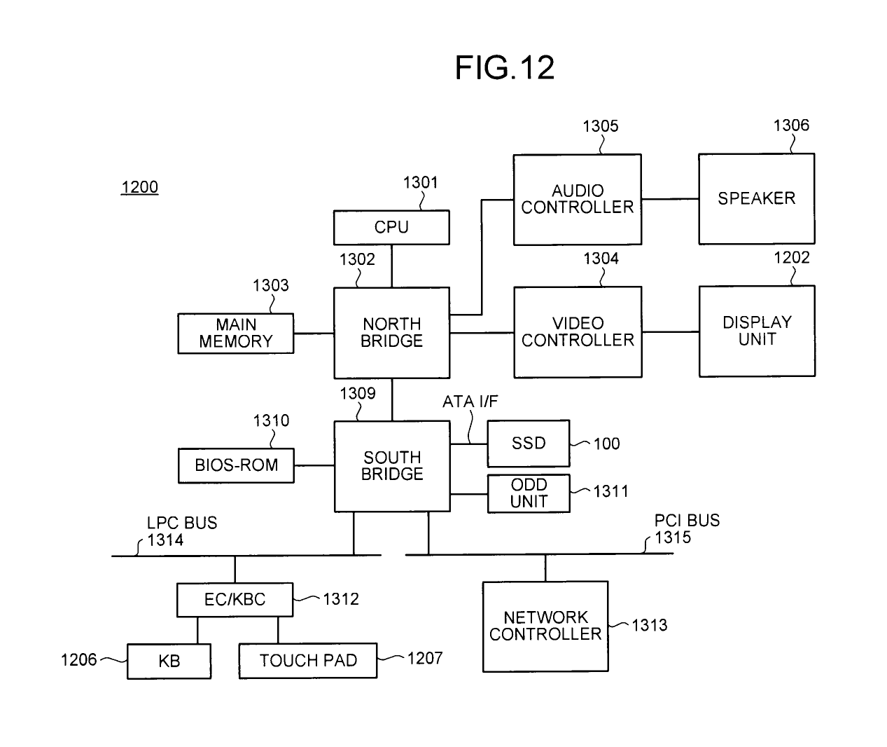

FIG. 12 is a diagram of a system configuration example of the personal computer mounted with the SSD. The personal computer 1200 includes a CPU 1301, a north bridge 1302, a main memory 1303, a video controller 1304, an audio controller 1305, a south bridge 1309, a basic input output system (BIOS)-ROM 1310, the SSD 100, an ODD unit 1311, an embedded controller/keyboard controller integrated circuit (IC) (EC/KBC) 1312, and a network controller 1313.

The CPU 1301 is a processor provided to control the operation of the personal computer 1200. The CPU 1301 executes an operating system (OS) loaded from the SSD 100 to the main memory 1303. When the ODD unit 1311 executes at least one of readout processing and writing processing on an inserted optical disk, the CPU 1301 executes the processing.

The CPU 1301 also executes a basic input output system (BIOS) stored in the BIOS-ROM 1310. The system BIOS is a computer program for controlling hardware in the personal computer 1200.

The north bridge 1302 is a bridge device that connects a local bus of the CPU 1301 and the south bridge 1309. A memory controller that access-controls the main memory 1303 is also incorporated in the north bridge 1302.

The north bridge 1302 also has a function of executing communication with the video controller 1304 and communication with the audio controller 1305 via an accelerated graphics port (AGP) bus or the like.

The main memory 1303 temporarily stores a computer program and data and functions as a work area of the CPU 1301. The main memory 1303 includes, for example, a dynamic random access memory (DRAM).

The video controller 1304 is a video reproduction controller that controls the display unit 1202 used as a display monitor of the personal computer 1200.

The audio controller 1305 is an audio reproduction controller that controls a speaker 1306 of the personal computer 1200.

The south bridge 1309 controls devices on a low pin count (LPC) bus 1314 and devices on a peripheral component interconnect (PCI) bus 1315. The south bridge 1309 controls the SSD 100, which is a storage device that stores various kinds of software and data, via an ATA interface.

The personal computer 1200 accesses the SSD 100 in sector units. A writing command, a readout command, a flash command, and the like are input to the SSD 100 via the ATA interface.

The south bridge 1309 also has a function for access-controlling the BIOS-ROM 1310 and the ODD unit 1311.

The EC/KBC 1312 is a one-chip microcomputer in which an embedded controller for power management and a keyboard controller for controlling the keyboard (KB) 1206 and the touch pad 1207 are integrated.

The EC/KBC 1312 has a function of turning on and off a power supply for the personal computer 1200 according to operation of a power button by the user. The network controller 1313 is a communication device that executes communication with an external network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory system including a controller and a memory unit, the controller comprising:
a generation unit that is configured to generate obfuscation information based on access request information relating to an access request;
an association unit that is configured to manage association of the obfuscation information with the corresponding access request information;
a retaining unit that is configured to be capable of retaining the obfuscation information generated by the generation unit;
an encoding/decoding unit that is configured to perform, by using the obfuscation information, an encoding processing for obfuscating data to be written to the memory unit and a decoding processing for deobfuscating data read out from the memory unit; and
a determination unit that is configured to determine, upon reception of the access request, whether or not the access request information relating to the access request is managed in the association unit, wherein
when the access request information is managed, the encoding/decoding unit performs, without generating the obfuscation information, the encoding processing or the decoding processing by using the obfuscation information retained in the retaining unit, and
when the access request information is not managed, the encoding/decoding unit performs, after the generation unit generates obfuscation information based on the access request information, the encoding processing or the decoding processing.

2. The system according to claim 1, wherein
the generation unit uses an access address relating to the access request as the access request information,
the association unit manages association of the obfuscation information with the corresponding access address, and
the determination unit determines whether or not the access address relating to the access request is identical to the previous access address.

3. The system according to claim 2, further comprising:
a calculation unit that is configured to calculate an adjacent address which is adjacent to the access address relating to the access request; wherein
the generation unit generates the obfuscation information based on the adjacent address while the encoding/decoding unit performs the encoding processing or the encoding processing,
the determination unit determine whether or not the access address is identical to the adjacent address calculated on the previous access request,
when the access address is identical to the adjacent address, the encoding/decoding unit performs, without generating the obfuscation information, the encoding processing or the decoding processing by using the obfuscation information generated in advance, and
when the access address is not identical to the adjacent address and the previous access address, the encoding/decoding unit performs, after the generation unit generates obfuscation information based on the access request information, the encoding processing or the decoding processing.

4. The system according to claim 1, wherein the encoding/decoding unit performs the encoding processing and the decoding processing on secret information which should not be read out to an external of the system.

5. The system according to claim 1, wherein the memory unit is disposed outside the controller.

6. The system according to claim 1, further comprising: a nonvolatile memory unit that is configured to be storing user data or a firmware of the system, wherein the controller controls data transfer between the memory unit and the nonvolatile memory unit.

7. The system according to claim 1, wherein the memory unit is a dynamic random access memory (DRAM).

8. The system according to claim 6, wherein the nonvolatile memory unit is a NAND type flash memory.

9. A semiconductor memory system including a controller and a memory unit, the controller comprising:
a generation unit that is configured to generate obfuscation information based on access address relating to an access request;
a calculation unit that is configured to calculate an adjacent address which is adjacent to the access address relating to the access request;
a retaining unit that is configured to be capable of retaining the obfuscation information generated by the generation unit;
an encoding/decoding unit that is configured to perform, by using the obfuscation information, an encoding processing for obfuscating data to be written to the memory unit and an encoding processing for deobfuscating data read out from the memory unit; and
a determination unit that is configured to determine, upon reception of the access request, whether or not the access address is identical to the adjacent address calculated on the previous access request, wherein
the generation unit generates the obfuscation information based on the adjacent address while the encoding/decoding unit performs the encoding processing or the encoding processing,
when the access address is identical to the adjacent address, the encoding/decoding unit performs, without generating the obfuscation information, the encoding processing or the decoding processing by using the obfuscation information generated in advance, and
when the access address is not identical to the adjacent address, the encoding/decoding unit performs, after the generation unit generates obfuscation information based on the access address, the encoding processing or the decoding processing.

10. The system according to claim 1, wherein the encoding/decoding unit performs the encoding processing and the decoding processing on secret information which should not be read out to an external of the system.

11. The system according to claim 1, wherein the memory unit is disposed outside the controller.

12. The system according to claim 1, further comprising: a nonvolatile memory unit that is configured to be storing user data or a firmware of the system, wherein the controller controls data transfer between the memory unit and the nonvolatile memory unit.

13. The system according to claim 1, wherein the memory unit is a dynamic random access memory (DRAM).

14. The system according to claim 12, wherein the nonvolatile memory unit is a NAND type flash memory.

15. A semiconductor memory system including a controller and a memory unit, the controller comprising:
a generation unit that is configured to generate obfuscation information based on an access time of an access request;
a calculation unit that is configured to calculate, upon reception of the access request, an expected next access time of a subsequent access request;
a retaining unit that is configured to be capable of retaining the obfuscation information generated by the generation unit;
an encoding/decoding unit that is configured to perform, by using the obfuscation information, an encoding processing for obfuscating data to be written to the memory unit and an encoding processing for deobfuscating data read out from the memory unit; and
a determination unit that is configured to determine, upon reception of the access request, whether or not the access time of the access request is identical to the expected next access time, wherein
the generation unit generates the obfuscation information based on the expected next access time while the encoding/decoding unit performs the encoding processing or the encoding processing,
when the access time is identical to the expected access time, the encoding/decoding unit performs, without generating the obfuscation information, the encoding processing or the decoding processing by using the obfuscation information generated in advance, and
when the access address is not identical to the expected access time, the encoding/decoding unit performs, after the generation unit generates obfuscation information based on the access time, the encoding processing or the decoding processing.

16. The system according to claim 1, wherein the encoding/decoding unit performs the encoding processing and the decoding processing on secret information which should not be read out to an external of the system.

17. The system according to claim 1, wherein the memory unit is disposed outside the controller.

18. The system according to claim 1, further comprising: a nonvolatile memory unit that is configured to be storing user data or a firmware of the system, wherein the controller controls data transfer between the memory unit and the nonvolatile memory unit and data transfer between the memory unit and the external.

19. The system according to claim 1, wherein the memory unit is a dynamic random access memory (DRAM).

20. The system according to claim 12, wherein the nonvolatile memory unit is a NAND type flash memory.
